(19) United States
(12) Patent Application Publication
(10) Pub. No.: US 2020/0216161 A1
(43) Pub. Date: Jul. 9, 2020

(54) MODULAR WINDSHIELD

(71) Applicant: Bell Textron Inc., Fort Worth, TX (US)

(72) Inventors: Paul Charles Griffiths, Roanoke, TX (US); Steven Loveland, Fort Worth, TX (US); Allen Brittain, Flower Mound, TX (US)

(73) Assignee: Bell Textron Inc., Fort Worth, TX (US)

(21) Appl. No.: 16/733,240

(22) Filed: Jan. 3, 2020

Related U.S. Application Data
(60) Provisional application No. 62/788,112, filed on Jan. 3, 2019.

(51) Int. Cl. B64C 1/14

(52) U.S. Cl. CPC B64C 1/1492

(57) ABSTRACT

A modular windshield has a central component and at least one side component. The central component is constructed of polycarbonate and the at least one side component is constructed of acrylic.

### CROSS-REFERENCE TO RELATED APPLICATIONS

This application claims priority to U.S. Provisional Patent Application No. 62/788,112, filed on Jan. 3, 2019 by Paul Charles Griffiths, et al., and titled “MODULAR WINDSHIELD,” the disclosure of which is incorporated by reference in its entirety.

### STATEMENT REGARDING FEDERALLY SPONSORED RESEARCH OR DEVELOPMENT

Not applicable.

### BACKGROUND

Aircraft sometimes comprise windshields with complicated geometries. In some cases, the entirety of a windshield may be constructed of a single acrylic or polycarbonate component. In spite of some windshields being constructed as singular components, some portions of those windshields are unavoidably more likely to be damaged in response to being struck by environmental elements, such as birds, when an aircraft is travelling at a relatively high speed. For example, consider a case where a windshield comprises both a central component that offers primary forward viewing from a cabin and opposing side components that offer angled forward and side views from the cabin. When the aircraft is travelling forward at high speed, the chances of a bird strike or other collision having a destructive effect to the central component is higher as compared to the likelihood that a side component being damaged. With such a unitary construction, if the central component is damaged, the entirety of the windshield must be replaced regardless of whether the side components were damaged.

### BRIEF DESCRIPTION OF THE DRAWINGS

FIG. 1 is an oblique view of an aircraft comprising a modular windshield according to this disclosure.

FIG. 2 is a front view of the aircraft of FIG. 1.

FIG. 3 is an oblique view looking forward through the modular windshield from within a cabin of the aircraft of FIG. 1.

### DETAILED DESCRIPTION

In this disclosure, reference may be made to the spatial relationships between various components and to the spatial orientation of various aspects of components as the devices are depicted in the attached drawings. However, as will be recognized by those skilled in the art after a complete reading of this disclosure, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

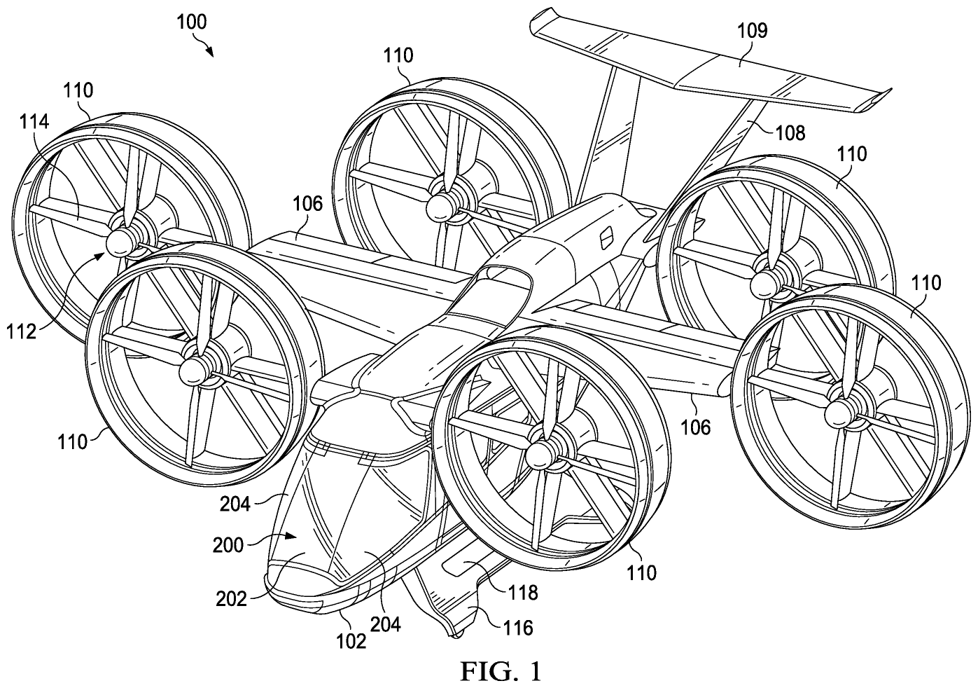

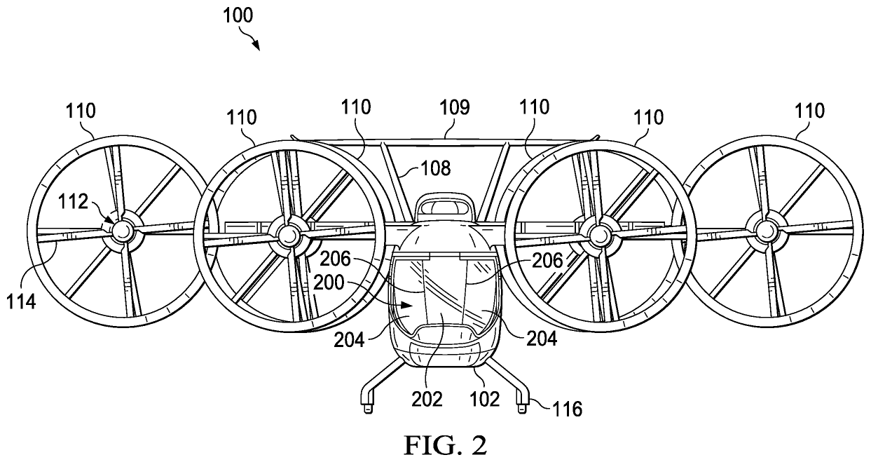

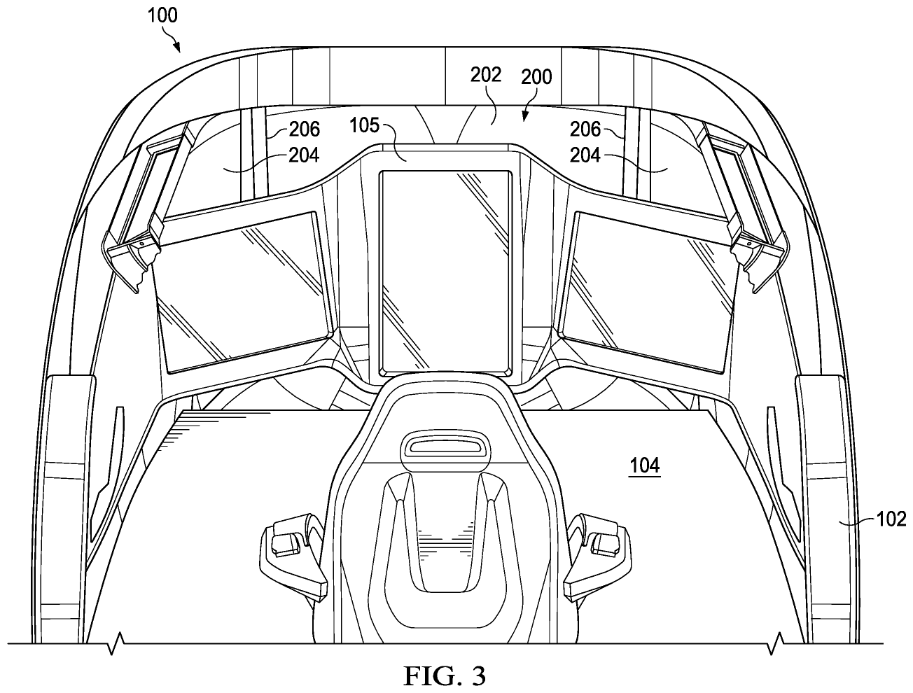

Referring now to FIGS. 1-3 an aircraft 100 according to this disclosure is shown. Aircraft 100 is generally configured as a vertical takeoff and landing (VTOL) aircraft that is operable in an airplane mode associated with forward flight and a helicopter mode associated with vertical takeoff from and landing to a landing zone. Aircraft 100 comprises a fuselage 102, a cabin 104, a dash 105 disposed in the cabin 104, a plurality of wings 106 extending from the fuselage 102, and an empennage 108 having a horizontal stabilizer 109. Aircraft 100 also comprises a plurality of ducted fans 110 that may be selectively rotated with respect to the fuselage 102 in order to transition the aircraft 100 between the airplane mode and the helicopter mode.

Each ducted fan comprises a rotor system 112 having a plurality of selectively rotatable rotor blades 114 configured to generate thrust when selectively rotated in each of the airplane mode and the helicopter mode. In the embodiment shown, aircraft 100 comprises six ducted fans 110. Two ducted fans 110 are carried by, supported by and/or otherwise coupled to the fuselage 102, two ducted fans 110 are coupled to the wings 106, and two ducted fans 110 are carried by, supported by, and/or otherwise coupled to the empennage 108. However, in alternative embodiments, any number of ducted fans 110 may be used depending on the configuration and design of the aircraft. Aircraft 100 also comprises a landing gear 116 configured to support aircraft 100 when not in flight. Additionally, landing gear 116 comprises an auxiliary folding step system 118 for use by occupants entering and exiting aircraft 100. The aircraft 100 further comprises a modular windshield 200.

The modular windshield 200 generally comprises a plurality of windshield components, namely, a central component 202 and two side components 204, and two support pillars 206. The pillars 206 are disposed between the central component 202 and each of the two side components 204. This modular setup allows for easier removal and/or replacement of any of the central component 202 and side components 204 without having to replace all three. In comparison, if the central component 202 and the two side components 204 were a single unitary structure, damage to one of the areas (central or one of the two sides) would necessitate replacement of the entire windshield at a greater cost and with greater difficulty. Instead, if the central component 202 is damaged by a bird strike or experiences some other failure, the central component 202 alone can be replaced without having to replace either of the side components. In some cases, the pillars 206 exist primarily within the cabin 104 with little or no portion of the pillar 206 disposed between the central component 202 and the side components 204. Alternatively, the pillars 206 can be provided more as an H-channel shape that receives the edges of the components 202, 204 therein.

Beyond the above-described advantage of being able to selectively replace the components 202, 204, the modular nature of the modular windshield 200 also allows design selections to be made that can improve resistance to windshield failure while also minimizing aircraft 100 weight.

In some cases, the side components 204 can be constructed of acrylic while the central component 202 is constructed of polycarbonate. In this way, the central component 202, which is more likely to experience a high energy strike by a bird or other matter, can be constructed relatively more robustly as compared to the acrylic side components 204. Of course, any other differentiated material selection can be made so that a relative strength or resistance failure capability of any of the central component 202 and the side components 204 can be tailored to the anticipated environments and uses of the aircraft 100.

In other cases, the side components 204 and the central component 202 can all be constructed of the same material, such as acrylic, but with different thicknesses. In other words, the central component 202 can be provided with a greater thickness as compared to the thickness of the side components 204.

In alternative embodiments, a modular windshield can comprise more or fewer component parts and the materials and thicknesses of the materials can be selected as desired while maintaining the ability to easily replace one component of the plurality of components.

At least one embodiment is disclosed, and variations, combinations, and/or modifications of the embodiment(s) and/or features of the embodiment(s) made by a person having ordinary skill in the art are within the scope of this disclosure. Alternative embodiments that result from combining, integrating, and/or omitting features of the embodiment(s) are also within the scope of this disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 95 percent, 98 percent, 99 percent, or 100 percent. Moreover, any numerical range defined by two R numbers as defined in the above is also specifically disclosed.

Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention. Also, the phrases “at least one of A, B, and C” and “A and/or B and/or C” should each be interpreted to include only A, only B, only C, or any combination of A, B, and C.

What is claimed is:

1. A modular windshield, comprising:
a central component; and
at least one side component.

2. The modular windshield of claim 1, wherein the central component is constructed of polycarbonate and wherein the at least one side component is constructed of acrylic.

3. The modular windshield of claim 1, wherein the central component comprises a thickness greater than a thickness of the at least one side component.

4. The modular windshield of claim 3, wherein the central component and the at least one side component are both constructed of acrylic.

5. The modular windshield of claim 1, wherein the at least one side component comprises a substantially curved portion configured to transition between a portion providing a side view and a portion providing a front view.

6. The modular windshield of claim 1, wherein the lowest portion of the central component is higher than the lowest portion of the at least one side component.

7. The modular windshield of claim 1, comprising two opposing side components that form mirrored equivalents of each other.

8. The modular windshield of claim 1, wherein a most forward portion of the central component is disposed further forward than a most forward portion of the at least one side component.

9. The modular windshield of claim 1, wherein the central component is curved.

10. An aircraft, comprising:
a modular windshield, comprising:
a central component; and
at least one side component.

11. The modular windshield of claim 10, wherein the central component is constructed of polycarbonate and wherein the at least one side component is constructed of acrylic.

12. The modular windshield of claim 10, wherein the central component comprises a thickness greater than a thickness of the at least one side component.

13. The modular windshield of claim 12, wherein the central component and the at least one side component are both constructed of acrylic.

14. The modular windshield of claim 10, wherein the at least one side component comprises a substantially curved portion configured to transition between a portion providing a side view and a portion providing a front view.

15. The modular windshield of claim 10, wherein the lowest portion of the central component is higher than the lowest portion of the at least one side component.

16. The modular windshield of claim 10, comprising two opposing side components that form mirrored equivalents of each other.

17. The modular windshield of claim 10, wherein a most forward portion of the central component is disposed further forward than a most forward portion of the at least one side component.

18. The modular windshield of claim 10, wherein the central component is curved.
